(19) United States
(12) Patent Application Publication
(10) Pub. No.: US 2021/0209524 A1
(43) Pub. Date: Jul. 8, 2021

(54) VEHICLE RESERVATION SYSTEMS WITH PREDICTIVE ADJUSTMENTS

(71) Applicant: Volvo Car Corporation, Göteborg (SE)

(72) Inventors: Nils Gunnar Oppelstrup, Stockholm (SE); Mikael Gunnar Löthman, Stockholm (SE); Tom Baylis, Stockholm (SE); Baptiste Rousset, Stockholm (SE)

(21) Appl. No.: 17/251,144

(22) PCT Filed: Jun. 12, 2019
(86) PCT No.: PCT/IB2019/054924

§ 371 Date: Dec. 10, 2020

Related U.S. Application Data
(60) Provisional application No. 62/683,665, filed on Jun. 12, 2018.
(60) Provisional application No. 62/841,412, filed on May 1, 2019.

(51) Int. Cl. G06Q 10/02; G06Q 10/06; G06Q 50/30

(52) U.S. Cl. CPC G06Q 10/02; G06Q 50/30; G06Q 10/06312; G06Q 10/06315

(57) ABSTRACT

This disclosure provides a shared mobile asset platform that predicts reservation extensions, and proactively adjusts future reservations. A computing system includes an interface, memory, and processing circuitry. The interface is configured to receive mobile asset usage information for a current mobile asset reservation while a mobile asset is in use. The memory is configured to store the mobile asset usage information for the current mobile asset reservation. The processing circuitry is configured to predict, prior to the mobile asset being returned, and based on the mobile asset usage information stored to the memory, a future return time for the mobile asset, wherein the return time is a time at which a current user of the mobile asset returns the mobile asset to an assigned return location. The processing circuitry is further configured to selectively adjust, based on the future return time, a future reservation for the mobile asset.

This application claims the benefit of Provisional U.S. Patent Application No. 62/841,412 filed on 1 May 2019 and Provisional U.S. Patent Application No. 62/683,665 filed on 12 Jun. 2018, the entire content of each of which is incorporated herein by reference.

### BACKGROUND

In shared mobile asset platforms, there is a limited number of mobile assets available and mobile asset reservations are frequently booked with little to no time between the end time of one reservation and a start time of another reservation. Unfortunately, the mobile assets are not always returned by the end of the reservation. In such instances, late returns may prevent other reservations from being successfully fulfilled, which may lead to a poor customer experience. One approach is to prevent back-to-back or short turnaround reservations in the shared mobile asset platform. However, such a solution may increase the number of mobile assets required to serve the same number of customers and reduce the effectiveness of the shared mobile asset platform.

### SUMMARY

In various examples, this disclosure provides a mechanism by which a shared mobile asset platform, such as a shared vehicle platform, may predict late returns and other instances where a reservation may be extended and proactively adjust future reservations that may be otherwise impacted by the extended prior reservation. Some aspects of this disclosure leverage historical data to generate recommendations and/or default options that are presented to a user when the user logs into or invokes a vehicle reservation interface via connected computing device. In some examples, the systems of this disclosure provide predictive feedback via the reservation interface in response to receiving a reservation request or portions of a reservation request. For example, the systems of this disclosure may generate, update, or recommend changes to a vehicle reservation in response to predicting that a vehicle will not be available at a particular pickup location during the time window in which the user has requested to or is predicted to request pickup of the vehicle.

The systems of this disclosure may also accept reservation extension inquiries and modify future reservations to accommodate the reservation extension. The systems may change which particular vehicle is assigned to a future reservation, change a return location for the vehicle assigned to the reservation being extended, or adjust cost associated with the reservation being extended or the future reservation that may be impacted, as non-limiting examples.

In one aspect, this disclosure is directed to a method. The method includes receiving, while a mobile asset is in use during a current mobile asset reservation, by a computing system, mobile asset usage information for the current mobile asset reservation. The method further includes predicting, prior to the mobile asset being returned, by the computing system and based on the mobile asset usage information, a future return time for the mobile asset, where the return time is a time at which a current user of the mobile asset returns the mobile asset to an assigned return location. The method further includes selectively adjusting, by the computing system and based on the future return time, a future reservation for the mobile asset.

In another aspect this disclosure is directed to a computing system. The computing system includes a communications interface, a memory, and processing circuitry in communication with the communications interface and the memory. The communications interface is configured to receive mobile asset usage information for a current mobile asset reservation while a mobile asset is in use during the current mobile asset reservation. The memory is configured to store the mobile asset usage information for the current mobile asset reservation. The processing circuitry is configured to predict, prior to the mobile asset being returned, and based on the mobile asset usage information stored to the memory, a future return time for the mobile asset, where the return time is a time at which a current user of the mobile asset returns the mobile asset to an assigned return location. The processing circuitry is further configured to selectively adjust, based on the future return time, a future reservation for the mobile asset.

In another aspect this disclosure is directed to an apparatus. The apparatus includes means for receiving, while a mobile asset is in use during a current mobile asset reservation, mobile asset usage information for the current mobile asset reservation. The apparatus further includes means for predicting, prior to the mobile asset being returned, based on the received mobile asset usage information, a future return time for the mobile asset, where the return time is a time at which a current user of the mobile asset returns the mobile asset to an assigned return location. The apparatus further includes means for selectively adjusting, based on the future return time, a future reservation for the mobile asset.

In another aspect this disclosure is directed to a non-transitory computer-readable storage medium encoded with instructions. The instructions, when executed, cause processing circuitry of a computing device to receive mobile asset usage information for a current mobile asset reservation while a mobile asset is in use during the current mobile asset reservation, to predict, prior to the mobile asset being returned, and based on the received mobile asset usage information stored, a future return time for the mobile asset, where the return time is a time at which a current user of the mobile asset returns the mobile asset to an assigned return location, and to selectively adjust, based on the future return time, a future reservation for the mobile asset.

The systems and techniques of this disclosure provide various technical improvements in the practical application of network-driven mobile asset management. As one example, the predictive reservation generation techniques of this disclosure improve data precision, in that the displayed or otherwise-output reservation information reflects a more realistic depiction of vehicle availability, whether with regards to vehicle type, time, location, or the like. As another example, the systems of this disclosure may mitigate computing resource usage in some instances by reducing the number of instances in which data is transmitted (whether from user to server or vice versa) in order to correct reservations if vehicle availability does not match the original reservation. As another example still, the systems of this disclosure may reduce the number of assets needed in a fleet supporting the shared mobile asset platform, thereby improving operating efficiency of the shared mobile asset platform.

The details of one or more examples of this disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system of this disclosure, in which a server device communicates via a wireless network with multiple automobiles and with a user-facing device.

FIGS. 2A and 2B are conceptual diagrams illustrating example user interfaces of this disclosure.

FIG. 3 is a block diagram illustrating an example apparatus configured to perform various techniques of this disclosure.

FIG. 4 is a flowchart illustrating an example process that a computing system may perform, in accordance with one example of the disclosure.

### DETAILED DESCRIPTION

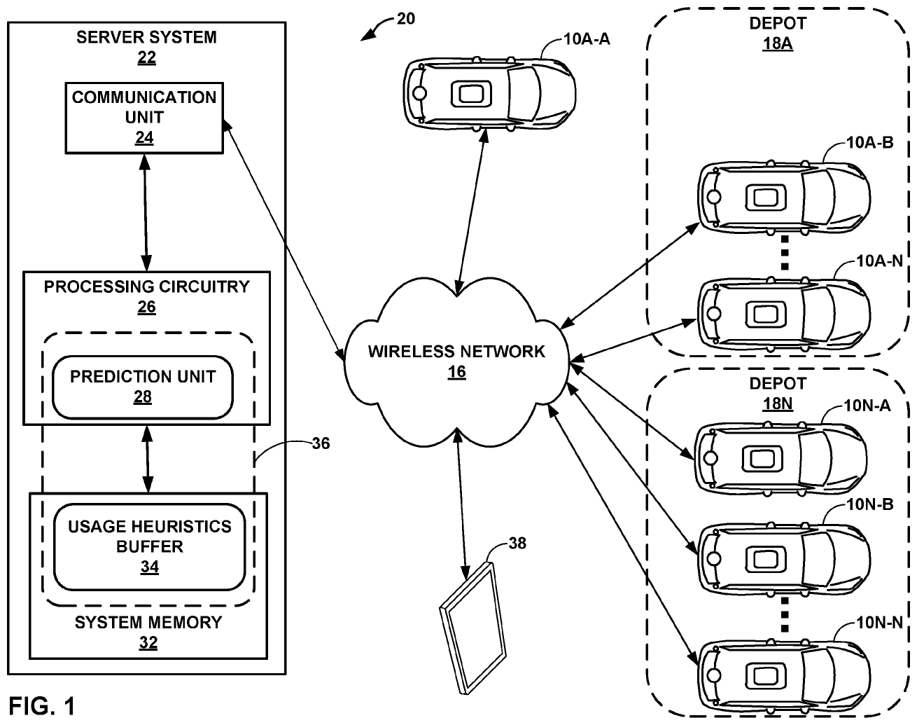

FIG. 1 is a block diagram illustrating an example system 20 of this disclosure, in which a server system 22 communicates via a wireless network 16 with multiple vehicles 10A-A to 10-N-N (collectively “vehicles 10”) and device 38. Each of vehicles 10 includes communication hardware that enables the respective vehicle 10 communicate with server 22 via wireless network 16. For instance, each of vehicles 10 may be equipped with telematics hardware, thereby integrating one or more of telecommunications, vehicular technologies (e.g., road transportation, road safety, electrical equipment such as sensors, instrumentation, wireless communications hardware, etc.), and computing equipment (e.g. multimedia technology, network connectivity via the Internet, etc.).

FIG. 1 illustrates an implementation of the techniques of this disclosure that provides configurations for both a user-facing device (e.g. a browser interface or a mobile application) as well as a backend server that work in tandem to implement asset reservations and bookings, and ultimately provide the user access to a reserved vehicle. Server system 22 of this disclosure leverages heuristic data and, in some examples, real-time traffic data to generate, update, or recommend certain reservation facets. User-facing device 38 outputs these reservation facets via one or more elements of a user interface (UI), and receives user inputs with regards to the reservation (e.g., further changes, acceptances, cancellations, etc.) from the user via the UI. User-facing device 38 relays information drawn from the received user input(s) to the backend server, enabling the backend server to finalize the reservation.

Server system 22 receives, from user-facing device 38, a user-initiated request to make a reservation. The reservation request may include a vehicle pickup time (or time window), a pickup location, a requested vehicle type, and in some instances, an explicit designation of a drop-off location (which may be the same depot 18 as the pickup location, or a different depot 18 from the pickup location). Before the start of the reservation pickup time window (and sometimes imminently before the pickup time window), server 22 may assign a particular vehicle 10 to effect mobile asset scheduling with respect to the instant reservation.

Subsequently, during the reservation, server system 22 may, in accordance with the techniques of this disclosure, predict that the assigned vehicle 10 will be returned late, i.e. at a time later than the asset return time assigned to the reservation. At that point, server system 22 may adjusts one or more subsequent reservations to which the same vehicle 10 is allotted, to maintain reservation data integrity, or may implement other measures to accommodate the parties associated with the future reservation(s). Example details of these aspects of this disclosure are discussed in greater detail below, with respect to FIGS. 1-4.

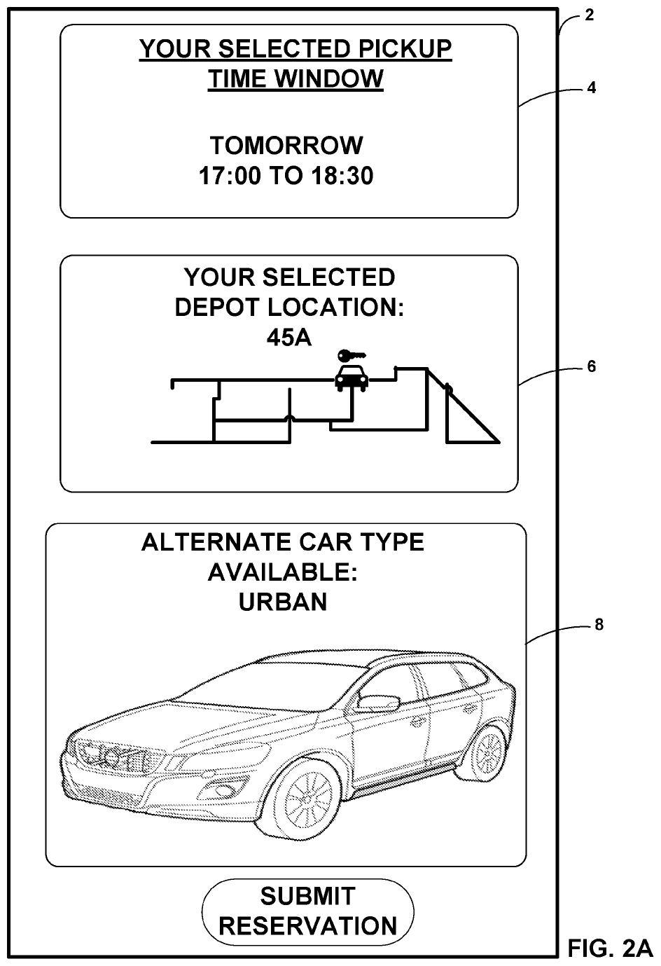

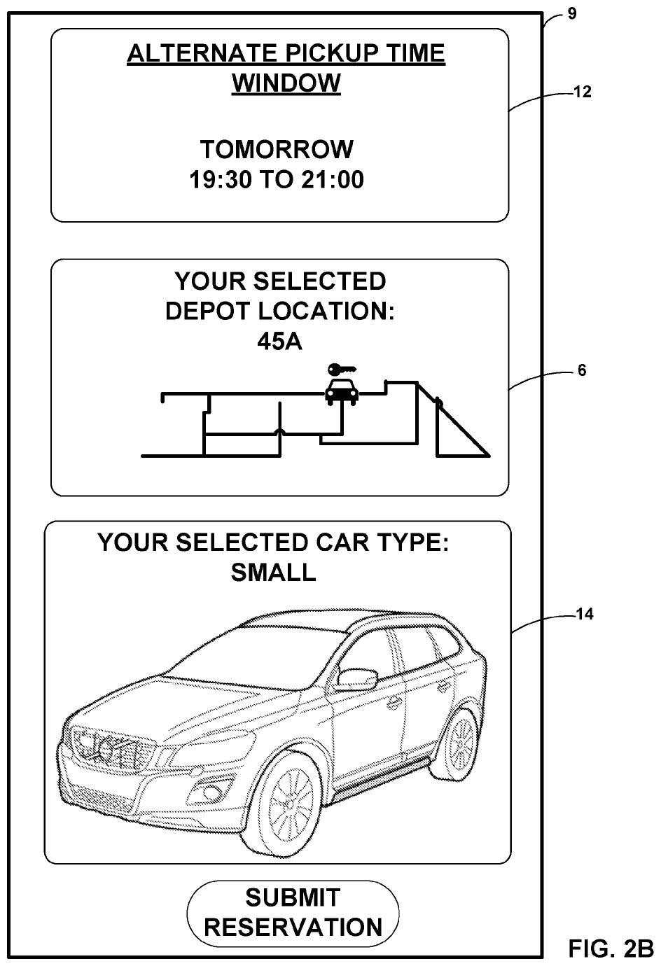

System 20 represents an example in which the techniques of this disclosure are implemented in a cloud-based manner, and in some cases, by leveraging machine learning (ML) technology. Server system 22 facilitates the cloud-based implementations of the techniques of this disclosure with respect to reservations with reservations for vehicles 10. In the example of FIG. 2, server system 22 receives the reservation requests from user-facing device 38. Server system 22 implements the cloud-based techniques of this disclosure to manage reservations for mobile assets, namely, vehicles 10 in this example. Server system 22 represents a portion or the entirety of a cloud-based system for asset management, some optional aspects of which are ML-based. That is, server system 22 is configured to receive and store availability and location information for vehicles 10, and to communicate portions of information to user-facing device 38.

Server system 22 implements various aspects of this disclosure to gather and process information pertaining to vehicles 10 and their expected checkout and/or return times to respective depots 18. Server system 22 may also generate predictive data that can be used to tune or edit reservation requests received from user-facing device 38. For instance, server system 22 uses communication unit 24 to receive and transmit information via over wireless network 16. It will be appreciated that communication unit 24 may equip server system 22 with an either a direct interface or a transitive interface to wireless network 16. In cases where communication unit 24 represents a direct interface to wireless network 16, communication unit 24 may include, be, or be part of various wireless communication hardware, including, but not limited to, one or more of Bluetooth®, 3G, 4G, 5G, or WiFi® radios. In cases where communication unit 24 represents a first link in a transitive interface to wireless network 16, communication unit 24 may represent wired communication hardware, wireless communication hardware (or some combination thereof), such as any one or any combination of a network interface card (e.g., an Ethernet card and/or a WiFi® dongle), USB hardware, an optical transceiver, a radio frequency transceiver, Bluetooth®, 3G, 4G, 5G, or WiFi® radios, and so on. Wireless network 16 may also enable the illustrated devices to communicate GPS and/or dGPS, such as location information of one or more of vehicles 10.

While communication unit 24 is illustrated as a single, standalone component of server system 22, it will be appreciated that, in various implementations, communication unit 24 may form multiple components, whether linked directly or indirectly. Moreover, portions of communication unit 24 may be integrated with other components of server system 22. At any rate, communication unit 24 represents network hardware that enables server system 22 to reformat data (e.g., by packetizing or depacketizing) for communication purposes, and to signal and/or receive data in various formats over wireless network 16.

Wireless network 16 may comprise aspects of the Internet or another public network. While not explicitly shown in FIG. 1 for ease of illustration purposes, wireless network 16 may incorporate network architecture comprising various intermediate devices that communicatively link server system 22 to one or more of vehicles 10. Examples of such devices include wireless communication devices such as cellular telephone transmitters and receivers, WiFi® radios, GPS transmitters, etc. Moreover, it will be appreciated that while wireless network 16 delivers data to vehicles 10 and collects data from vehicles 10 using wireless “last mile” components, certain aspects of wireless network 16 may also incorporate tangibly-connected devices, such as various types of intermediate-stage routers.

Communication unit 24 of server system 22 is communicatively coupled to processing circuitry 26 of server system 22. Processing circuitry 26 may be formed in one or more microprocessors, application specific integrated circuits (ASICs), field programmable gate arrays (FPGAs), digital signal processors (DSPs), fixed function circuitry, programmable processing circuitry, various combinations of fixed function circuitry with programmable processing circuitry, or other equivalent integrated logic circuitry or discrete logic circuitry. Fixed-function circuitry refers to circuits that provide particular functionality and are preset on the operations that can be performed. Programmable processing circuitry refers to circuits that can programmed to perform various tasks and provide flexible functionality in the operations that can be performed. For instance, programmable processing circuitry may represent hardware that executes software or firmware that cause programmable circuits to operate in the manner defined by instructions of the software or firmware. Fixed-function circuitry may execute software instructions (e.g., to receive parameters or output parameters), but the types of operations that the fixed-function processing circuits perform are generally immutable. In some examples, one or more of the units may be distinct circuit blocks (fixed-function or programmable), and in some examples, the one or more units may be integrated circuits. As shown in FIG. 2, processing circuitry 26 is communicatively coupled to system memory 32 of server system 22.

System memory 32, in some examples, are described as a computer-readable storage medium and/or as one or more computer-readable storage devices. In some examples, system memory 32 may include, be, or be part of temporary memory, meaning that a primary purpose of system memory 32 is not long-term storage. System memory 32, in some examples, is described as a volatile memory, meaning that system memory 32 do not maintain stored contents when the computer is turned off. Examples of volatile memories include random access memories (RAM), dynamic random access memories (DRAM), static random access memories (SRAM), and other forms of volatile memories known in the art.

In some examples, system memory 32 are used to store program instructions for execution by processing circuitry 26. System memory 32, in one example, are used by logic, software, or applications implemented at server system 22 to temporarily store information during program execution. System memory 32, in some examples, also include one or more computer-readable storage media. Examples of such computer-readable storage media may include a non-transitory computer-readable storage medium, and various computer-readable storage devices. System memory 32 may be configured to store larger amounts of information than volatile memory. System memory 32 may further be configured for long-term storage of information. In some examples, system memory 32 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Vehicles 10 represent vehicles configured to automate one or more tasks associated with vehicle operation. In examples where vehicles 10 are capable of automating some, if not all of the tasks associated with vehicle operation except for providing input related to destination selection. It will be appreciated that vehicles 10 are capable of automating various tasks, although not every vehicle of vehicles 10 may implement automation of each function at all times. That is, in some instances, one or more of vehicles 10 may disable the automation of certain tasks, e.g., based on a user input to instigate such a disabling of one or more operation tasks.

Vehicles 10 are assumed in the description below as passenger cars, although aspects of this disclosure may apply to any type of vehicle capable of conveying one or more occupants and operating autonomously, such as buses, recreational vehicles (RVs), semi-trailer trucks, tractors or other types of farm equipment, trains, motorcycles, personal transport vehicles, and so on. Each of vehicles 10 is equipped with communication logic and interface hardware, by which each of each of vehicles 10 may send and receive data over wireless network 16. Each of vehicles 10 is also equipped with telematics hardware, which may include any of the communication logic and interface hardware mentioned above.

One or more of vehicles 10 may transmit or “upload” location, speed, and other information to server system 22 via wireless network 16, using the telematics functionalities with which vehicles 10 are equipped. For instance, communication unit 24 may receive data packets from one or more of vehicles 10. Communication unit 24 may decapsulate the packets to obtain respective payload information of the packets. In turn, communication unit 24 may forward the payloads to processing circuitry 26. In these and other examples, communication unit 24 may receive information regarding traffic conditions, user statistics, etc. from other sources, such as publicly-available information from the Internet, from other user-facing devices operated by other users, etc.

Processing circuitry 26 may implement further processing of the payload data of the packets received from vehicles 10 and the other sources described above. For instance, processing circuitry 26 may determine whether or not a particular payload is pertinent to vehicle 10A-A, or to vehicle 10A-B, to an identity of a user currently driving or schedule to pick up one of vehicles 10, etc. Additionally, processing circuitry 26 may store portions of decapsulated, processed payloads to system memory 32. In some specific examples, processing circuitry 26 may store the selected portions of the processed payloads to usage heuristics buffer 34, which is implemented in system memory 32.

Processing circuitry 26 of server system 22 implements various techniques of this disclosure to analyze and update or analyze and recommend updates with respect to reservations received from user-facing device 38. In turn, processing circuitry 26 may invoke communication unit 24 to transmit updated reservation information and/or to transmit update recommendations to user-facing device 38. In the example of FIG. 2, processing circuitry 26 includes a prediction unit 28. Processing circuitry 26 may invoke prediction unit 28 to dynamically update or generate recommended updates to a particular reservation request received from user-facing device 38.

For example, prediction unit 28 may obtain data from usage heuristics buffer 34, and use the data to generate updates or recommended updates. By utilizing data provided by usage heuristics buffer 34, prediction unit 28 enables server system 22 to implement ML-based functionalities to update aspects of a reservation or interactively recommend updates to a reservation received from user-facing device 38. In some examples, prediction unit 28 may obtain, from usage heuristics buffer 34, information indicating car-return time distributions for the current driver of vehicle 10A-A, which is presently not stationed at any of depots 18, and is therefore presumed to be on the road. Upon receiving a reservation request from user-facing device 38 for a vehicle of the same car type as vehicle 10A-A, with a pickup location of depot 18A, and at a time window that begins immediately after the scheduled return time window for the previous user of vehicle 10A-A, prediction unit 28 may analyze the previous user's car return history. If prediction unit 28 determines that the previous user's car return history indicates at least a threshold probability of vehicle 10A-A being returned to depot 18A after the start of the pickup time window received from user-facing device 38, and that none of the remaining vehicles 10A are of the same car type as requested, prediction unit 28 may generate an update with respect to the reservation.

Prediction unit 28 may recommend alternate car types (e.g. car types available among vehicles 10A-B through 10A-N) at depot 18A, or may suggest a later pickup time for vehicle 10A-A at depot 18A. In some examples, prediction unit 28 may generate an update that maintains the same car type and pickup time provided in the reservation request, but may suggest a different pickup location, such as at depot 18B or another depot location. In some examples, prediction unit 28 may substitute or supplement the data obtained from usage heuristics buffer 34 with information obtained from other sources, such as real-time traffic information or weather information at the current location of vehicle 10A-A or surrounding depot 18A.

In these examples, prediction unit 28 may generate the reservation updates based on the supplemental information, whether in combination with or agnostic of the historical data available from usage heuristics buffer 34. Prediction unit 28 and usage heuristics buffer 34 are shown in FIG. 1 as collectively forming a scheduling engine 36. It will be appreciated that, in accordance with the different use case scenarios described above, scheduling engine 36 need not draw from usage heuristics buffer 34 in all instances, and that scheduling engine 36 may also draw on information available from other sources in forming reservation updates.

Again, scheduling engine 36 executes the functionalities of scheduling car requests (booking request) on a fleet of cars, of which vehicles 10 are a part. Scheduling engine 36 is configured to handle several specific use cases and meet certain requirements under various sets of circumstances. In some examples, scheduling engine 36 is configured to extend an ongoing booking (e.g., by setting a later-than-presently-scheduled end time) based on various stimuli. In some examples, scheduling engine 36 implements a user-initiated extension of the booking. In these examples, scheduling engine 36 may receive an active or explicit request from the present user of vehicle 10A-A to extend the presently ongoing or in-use booking. Scheduling engine 36 may determine, from the user-activated request, that user has asked for how long the current booking of vehicle 10A-A can be extended. Scheduling engine 36 may determine the start time of the next reservation of vehicle 10A-A from the request received from user-facing device 38, and may either automatically extend the ongoing booking or use communication unit 24 to transmit a time corresponding to the start time of the next-scheduled booking of vehicle 10A-A (e.g., as reflected in the request received from user-facing device 38).

In other examples, scheduling engine 36 may implement a system-initiated auto-extension of the current booking of vehicle 10A-A while vehicle 10A-A is still on the road and not yet returned to depot 18A. In these examples, scheduling engine 36 may automatically extend the present booking if scheduling engine 36 determines that the end time of the current booking is imminent, and that vehicle 10A-A is either not at depot 18A (a binary decision) or is at a threshold distance away from depot 18A. Scheduling engine 36 implements this procedure in order to flag unavailability of vehicle 10A-A if, above a threshold degree of certainty, vehicle 10A-A will not be back at depot 18A in time for the next booking request received from user-facing device 38. In this way, scheduling engine 36 may auto-extend the current booking to block conflicting reservations of vehicle 10A-A, and instead process the next-received booking request for another one of vehicles 10.

In some examples, scheduling engine 36 may provide journey optimization to better achieve the goals of car availability and utilization/throughput with respect to vehicles 10. Scheduling engine 36 may incorporate, into the scheduling operations of this disclosure, the provision for one or more of vehicles 10 to be moved freely between depots 18, so that vehicles 10 are located where they are needed for users, while keeping vehicles 10 available for booking. Scheduling engine 36 may also generate commands/recommendations that pertain to moving vehicles 10 between depots 18. For instance, scheduling engine 36 may generate bookings that originate with a pickup at depot 18A, and ending with a car return at depot 18B. Scheduling engine 36 may generate future bookings based on the availability of the respective vehicle 10 for bookings in the respective depot 18 at which the vehicle 10 is expected to be located at the time of the next incoming reservation request.

Scheduling engine 36 also provides server system 22 with car replacement capabilities, in terms of replenishing inventory at those of depots 18 that might not be readily equipped to meet demand in the future. Scheduling engine 36 may generate instructions to replace subsets of vehicles 10 in depots 18 while minimizing effects to end users, or to potentially create an edit-agnostic system from the perspectives of the end users. By continually and frequently calculating new schedules and deferring car assignments as late as possible with respect to fulfilling a specific booking request, scheduling engine 36 may improve resource usage in terms of booking fulfillment.

Scheduling engine 36 may also implement an auto-end functionality with respect to booking commitments that are unfulfilled by the booking user. In cases where the user fails to affirmatively end their booking after returning a respective vehicle 10, scheduling engine 36 may automatically end the booking if the originally-scheduled end time has passed and the information received via the telematics system of the respective vehicle 10 indicates that the respective vehicle 10 is located in one of depots 18, the engine is not running, and, optionally, that the respective vehicle 10 is locked.

Aspects of the configurations discussed herein may make scheduling engine 36 performant. The performance of scheduling engine 36 enables features such as instant scheduling when placing a booking in response to receiving a request from user-facing device 38. Features such as instant booking improve the efficiency of server 22 with respect to mobile asset management in various scenarios, such as when the user of user-facing device 38 is located at or near one of depots 18 when attempting to reserve one of vehicles 10 (as in the case of maintenance users).

Scheduling engine 36 may also provide querying support. In various examples, scheduling engine 36 may receive and process suggestions from users with respect to tuning of the scheduling operations described herein, and may also receive and process journey edit inputs from the users. Scheduling engine 36 may also enable server system 22 to balance car utilization (e.g., by implementing wear-leveling) among vehicles 10. In order to manage the fleet of vehicles 10 in a financially sustainable way, optimizing the residual value of vehicles 10 is a factor. Scheduling engine 36 may address residual value upkeep by taking the odometer value and age of each of vehicles 10 into account when scheduling car requests. For instance, if two of vehicles 10 meet the availability and car-type requirements of a particular request, scheduling engine 36 may assign the newer and/or lower-mileage choice to the booking. The ultimate goal is to have all of vehicles 10 being driven as close as possible to the same distance over equal time, thereby implementing wear-leveling across the fleet of vehicles 10. In some examples, scheduling engine 36 may change the vehicle 10 assigned to a later reservation even though the previous (extended or otherwise) reservation may not cause a conflict with the later reservation. Instead, in this example, scheduling engine 36 may determine that the vehicle assignment needs to be changed in order to more evenly spread usage across the fleet of vehicles 10.

Scheduling engine 36 may also implement certain monitoring and alerting functionalities. Scheduling engine 36 may process incoming data to monitor user behavior with respect to automobiles. In one example, scheduling engine 36 processes no-show data. In this example, scheduling engine 36 detects that a user has an active ongoing booking but has not accessed the assigned vehicle 10. This event is termed as a “no show” and by detecting the no show, scheduling engine 36 may free up the respective vehicle 10 to fulfill other bookings or standby bookings. These no-show contingency measures implemented by scheduling engine 36 also mitigate wear-leveling diminishments caused by no-shows.

In some examples, scheduling engine 36 may implement booking updates to deal with late return occurrences. If scheduling engine 36 determines that an ongoing booking is about to end, scheduling engine 36 may ramp up the car location sampling rate such that the position of the respective vehicle 10 is fetched every X minutes. The position of the respective vehicle 10 and the position of the destination depot 18 as set out in the booking is sent to a third party system (e.g. a navigation system or online mapping system) in order to estimate the time of arrival. By detecting late arrivals before they occur, scheduling engine 36 gives each subsequent customer time and data-based support to act and mitigate the problem of not having the booked vehicle 10 available at the time of the subsequent booking(s).

Scheduling engine 36 may also address scheduling problems arising from one of vehicles 10 not being returned at the particular destination depot 18 set out in the booking. If scheduling engine 36 determines that an ongoing booking has ended, scheduling engine 36 may compare the position of the respective vehicle 10 to the location of the destination depot 18 specified in the booking. If scheduling engine 36 determines that the distance is beyond a threshold distance (in some examples, after taking into account current weather and/or traffic conditions on the path from the car's position to the destination depot), scheduling engine 36 may trigger an alert.

If scheduling engine 36 determines that one of vehicles 10 is being or was driven without a booking processed via server system 22, scheduling engine 36 may trigger an alert. In this way, scheduling engine 36 implements functionalities that detect surreptitious use of vehicles 10 by parties who should not have access to vehicles 10.

Scheduling engine 36 may execute one or more algorithms in hardware to perform the functionalities described herein. One example is an extensive car scheduler algorithm that takes as inputs all car requests and available car information. The extensive car scheduler algorithm evaluates all possible combinations of schedules until identifying a suitable (e.g., best possible) solution to the current scheduling problem.

Another example is a partitioned car scheduler. The partitioned car scheduler algorithm is a pre-processing step to the “extensive car scheduler” described above. The partitioned car scheduler splits the scheduling problem into sub-parts that can run in parallel, either in different threads on the same device or on separate servers. The partitioned car scheduler algorithm enables high performant scheduling.

FIGS. 2A and 2B are conceptual diagrams illustrating example user interfaces of this disclosure. FIG. 2A illustrates user interface (UI) 2 and FIG. 2B illustrates UI 9, each of which represent UIs that systems of this disclosure may cause a user-facing device to output for display, to elicit user input for updating a reservation request. UI 2 of FIG. 2A illustrates a use case scenario in which the scheduling engine of this disclosure outputs an offer of an alternate vehicle type in response to the generation or submission of a reservation request. UI 2 includes a time element 4, a location element 6, and a vehicle type element 8. In FIG. 2A, time element 4 indicates the user's selected time window for vehicle pickup. Also in FIG. 2A, location element 6 indicates the user's selected depot as the vehicle pickup location. As such, FIG. 2A illustrates a use case scenario in which the scheduling engine of this disclosure does not determine or detect a need to change or recommend changes to the user's selected pickup time or selected depot location.

In FIG. 2A, vehicle type element 8 indicates a change or recommended change to the user's selected car type. In the particular use case scenario of FIG. 2A, scheduling engine 36 indicates that an alternate car type (in this case, a wagon) is available at the user's selected depot during the user's selected pickup time window. In this example, scheduling engine 36 of this disclosure may determine, based on one or more factors, that the user's selected car type will not be available at the selected depot location during the user's selected pickup time window. In one example, scheduling engine 36 may determine, with at least a threshold measure of certainty, that one or more users who have prior reservations for the instant user's selected car type have a history of late returns.

In another example, scheduling engine 36 may determine that the user's selected pickup time occurs during a high traffic period (e.g., so-called “rush hour”) in the locality of the selected depot, and that all vehicles of the user's selected car type are booked for the time slot immediately preceding the user's selected pickup window. In this example, scheduling engine 36 may combine these two known conditions and determine that an alternate car type should be recommended to best maintain the integrity of the reservation. In any event, scheduling engine 36 may use various types of heuristic data to generate the alternate car type suggestion illustrated in car type element 8 of UI 2.

UI 9 of FIG. 2B illustrates a use case scenario in which scheduling engine 36 of this disclosure outputs an offer of an alternate vehicle pickup time window in response to the generation or submission of a reservation request. UI 9 includes time element 12, location element 6 (similar to the like-numbered element of FIG. 2A), and vehicle type element 14. In FIG. 2B, as also in the case of FIG. 2A, location element 6 indicates the user's selected depot as the vehicle pickup location. In FIG. 2B, car type element 14 indicates that the user's selected car type (in this case, a compact sport utility vehicle) is available at the selected depot location. As such, FIG. 2A illustrates a use case scenario in which scheduling engine 36 of this disclosure does not determine or detect a need to change or recommend changes to the user's selected depot location or selected vehicle type.

In FIG. 2B, time element 12 indicates a change or recommended change to the user's selected vehicle pickup time window. In the particular use case scenario of FIG. 2B, scheduling engine 36 indicates that the user's selected car type is available at the user's selected depot location, but at a different time from the user's selected pickup time window. In one example, scheduling engine 36 of this disclosure may determine, based on one or more factors, that the user's selected car type be available at the selected depot location at a time slot that is subsequent to the user's selected pickup time window. In one example, scheduling engine 36 may determine, with at least a threshold measure of certainty, that one or more users who have prior reservations for the instant user's selected car type have a history of late returns.

In another example, scheduling engine 36 may determine that the user's selected pickup time occurs during a high traffic period (e.g., so-called “rush hour”) in the locality of the selected depot, and that all vehicles of the user's selected car type are booked for the time slot immediately preceding the user's selected pickup window. In this example, scheduling engine 36 may combine these two known conditions and determine that an alternate (e.g., later) pickup time window should be recommended to best maintain the integrity of the reservation. In any event, scheduling engine 36 may use various types of heuristic data to generate the alternate vehicle pickup time window suggestion illustrated in time element 12 of UI 9.

The systems of this disclosure may relay data to various types of client devices or user-facing devices to cause UIs 2 and 9 to be output for display. In various examples, the user-facing device(s) that output UIs 2 and 9 for display may include, be, or be part of one or more of a smartphone, a tablet computer, a laptop computer, a desktop computer, a television with interactive capabilities (e.g., a smart TV), a video gaming console paired with an appropriate display device, or any other device or combination of devices capable of receiving data from a user and receiving/transmitting data over a network, such as a local area network (LAN), a wide area network (WAN), an enterprise network, or a public network such as the Internet. UIs 2 and 9 are described as being output for display by user-facing device 38 of FIG. 1, as an example.

User-facing device 38 may include various hardware components configured, whether individually or in combination, to output UI 9 for display. Examples of these hardware components include network interface hardware, processing circuitry, and one or more memory devices. The memory devices may store instructions for execution of one or more applications. The memory devices may include one or more computer-readable storage media (e.g., a non-transitory computer-readable storage medium), computer-readable storage devices, etc. Examples of memory devices include, but are not limited to, a random access memory (RAM), an electrically erasable programmable read-only memory (EEPROM), flash memory, or other medium that can be used to carry or store desired program code in the form of instructions and/or data structures and that can be accessed by a computer or one or more processors (e.g., the processing circuitry described above).

In some aspects, the memory devices may store instructions that cause the processing circuitry of user-facing device 38 to perform the functions ascribed in this disclosure to the processing circuitry. Accordingly, at least one of the memory devices may represent a computer-readable storage medium having instructions stored thereon that, when executed, cause one or more processors (e.g., the processing circuitry) to perform various functions. For instance, at least one of the memory devices is a non-transitory storage medium. The term “non-transitory” indicates that the storage medium is not embodied in a carrier wave or a propagated signal. However, the term “non-transitory” should not be interpreted to mean that the memory devices are non-movable or that the stored contents are static. As one example, at least one of the memory devices described herein can be removed from user-facing device 38, and moved to another device. As another example, memory, substantially similar to one or more of the above-described memory devices, may be inserted into one or more receiving ports of user-facing device 38. In certain examples, a non-transitory storage medium may store data that can, over time, change (e.g., in RAM).

The processing circuitry of user-facing device 38 may be formed in one or more microprocessors, application specific integrated circuits (ASICs), field programmable gate arrays (FPGAs), digital signal processors (DSPs), fixed function circuitry, programmable processing circuitry, any combination of fixed function circuitry and programmable processing circuitry, or other equivalent integrated logic circuitry or discrete logic circuitry. Fixed-function circuitry refers to circuits that provide particular functionality and are preset on the operations that can be performed. Programmable processing circuitry refers to circuits that can programmed to perform various tasks and provide flexible functionality in the operations that can be performed. For instance, programmable processing circuitry may represent hardware that executes software or firmware that cause programmable circuits to operate in the manner defined by instructions of the software or firmware. Fixed-function circuitry may execute software instructions (e.g., to receive parameters or output parameters), but the types of operations that the fixed-function processing circuits perform are generally immutable. In some examples, one or more of the units may be distinct circuit blocks (fixed-function or programmable), and in some examples, the one or more units may be integrated circuits.

Examples of network interface hardware that user-facing device 38 may incorporate include a direct interface or a transitive interface to a network, such as a wireless or wired network. In cases of a direct interface to a wireless network, such interface hardware may include, be, or be part of various wireless communication hardware, including, but not limited to, one or more of Bluetooth®, 3G, 4G, 5G, or WiFi® radios. In cases of a wired network or a first link in a transitive interface to a wireless network, the interfaces may incorporate wired communication hardware, wireless communication hardware (or some combination thereof), such as any one or any combination of a network interface card (e.g, an Ethernet card and/or a WiFi® dongle), USB hardware, an optical transceiver, a radio frequency transceiver, Bluetooth®, 3G, 4G, 5G, or WiFi® radios, and so on. User-facing device 38 may also communicate location information (e.g., in the form of GPS and/or dGPS coordinates, logical network addresses, etc.) to server system 22.

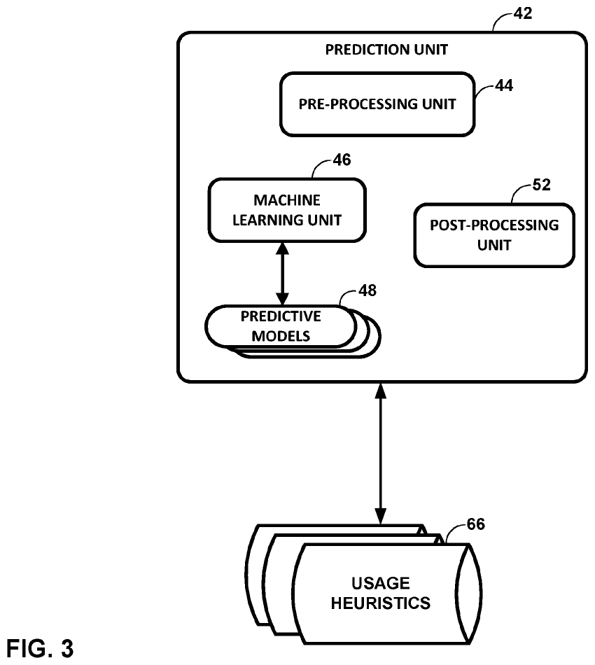

FIG. 3 is a block diagram illustrating an example apparatus configured to perform the techniques of this disclosure. In particular, FIG. 3 shows portions of server system 22 of FIG. 1 in more detail.

In the example of FIG. 3, prediction unit 42 includes a pre-processing unit 44, a machine learning unit 46, and a post-processing unit 52. Pre-processing unit 44 is configured to make the unstructured raw input (i.e., location information and/or the speed at which vehicle 10 is traveling) into structuralized data that can be processed by other components of prediction unit 42 and/or of server system 22.

Pre-processing unit 44 may be configured to provide the structuralized data to machine learning unit 46. Machine learning unit 46 may implement various forms of machine learning technology, including, but not limited to, artificial neural networks, deep learning, support vector machine technology, Bayesian networks, etc. Using the structuralized data obtained from pre-processing unit 44, machine learning unit 46 may perform comparison operations with respect to predictive model 48. If machine learning unit 46 detects a discrepancy between any of the structuralized data received from pre-processing unit 44 and the road conditions reflected in predictive model 48, machine learning unit 46 may update the data of predictive model 48 to incorporate the more up-to-date availability information of depots 18. In this way, machine learning unit 46 implements dynamic model generation or model updating operations of this disclosure to use and to share updates to obsolete availability information regarding vehicles 10.

Post-processing unit 52 may obtain the updated version of predictive model 48, and convert the data of predictive model 48 into final output. For example, post-processing unit 52 may be configured to translate predictive model 48 into one or more machine-readable formats. In various examples, prediction unit 42 may provide the output generated by post-processing unit 52 to one or more display operation applications 56.

The instructions that define prediction unit 42 may be stored in a memory. In some examples, the instructions that define prediction unit 42 may be downloaded to the memory over a wired or wireless network. In some examples, the memory may be a temporary memory, meaning that a primary purpose of the memory is not long-term storage. The memory 64 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

The memory may include one or more non-transitory computer-readable storage mediums. The memory may be configured to store larger amounts of information than typically stored by volatile memory. The memory may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Memory 64 may store program instructions (e.g., prediction unit 42) and/or information (e.g., predictive model(s) 48) that, when executed, cause the processing circuitry to perform the techniques of this disclosure.

As shown, prediction unit 42 may generate one or more predictive models 48 by drawing on information from usage heuristics 66, which is illustrated as being implemented in a remote store in FIG. 3. One or more predictive models 48 represent scheduling information with updates or suggested updates, as described above in greater detail.

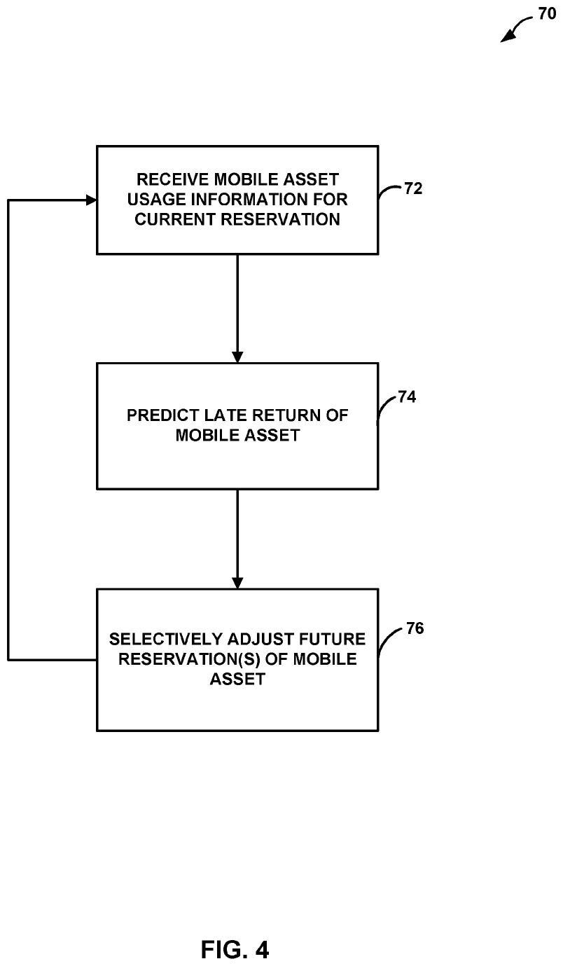

FIG. 4 is a flowchart illustrating an example process 70 that system 20 may perform, in accordance with one example of the disclosure. One or more processors, such as processing circuitry 26 of server system 22 may be configured to perform the techniques shown in FIG. 4. As described above, system 20 represents a cloud-based implementation of the techniques described herein. Aspects of process 70 is described herein as being performed by scheduling engine 36 implemented in processing circuitry 26 and system memory 32 of server system 22.

In accordance with process 70 of FIG. 4, scheduling engine 36 may receive mobile asset usage information for a current reservation (72). For example, scheduling engine 36 may receive the mobile asset usage information for a current mobile asset reservation while the mobile asset is in use during the current mobile asset reservation. In turn, scheduling engine 36 may predict a late return of the mobile asset (74). For instance, scheduling engine 36 may predict, prior to the mobile asset being returned, and based on the received mobile asset usage information, a future return time for the mobile asset, where the return time is a time at which a current user of the mobile asset returns the mobile asset to an assigned return location. In this example, the predicted future return time for the mobile asset may be late, in that the predicted future return time is predicted to occur subsequent to the ending of the reservation's allotted time interval.

Scheduling engine 36 may selectively adjust one or more future reservations of the mobile asset (76). For instance, scheduling engine 36 may selectively adjust the future reservation(s) for the mobile asset based on the future return time. In this example, because the future return time of the current mobile asset reservation/booking is predicted to be late, scheduling engine 36 may selectively adjust the future reservation(s) to accommodate the user(s) holding the future reservation(s) in the event that the prediction of the late return time of the mobile asset is indeed accurate. In turn, scheduling engine 36 may continue to receive additional mobile asset usage information for the current reservation (iteratively returning to step 72) until the current reservation is terminated.

In various examples, server system 22 may obtain the predictive movement model from a local storage device, such as memory 64, or from a remote device, such as from server system 22. In various examples, server system 22 may control one or more display devices (e.g., one or more of in-vehicle displays 33) in communication with processing circuitry of server system 22 to adjust video data output by the one or more display devices based on the updated predictive movement model.

In turn, server system 22 may detect a discrepancy between the road condition information from sensor hardware 12 and the predictive movement model (76). For example, server system 22 may invoke machine learning unit 46 to perform the comparison operations used to detect the discrepancy. Server system 22, such as by invoking machine learning unit 46, may update the predictive movement model using the road condition information received from sensor hardware 12 (78). That is, server system 22 may update the predictive movement model in response to the detected discrepancy between the dynamically-collected road condition information and the predictive movement model.

In turn, server system 22 may store the updated predictive movement model (82). In various examples, server system 22 may store the updated predictive movement model locally (e.g. to memory 64) or to a remote location (e.g., by transmitting the updated predictive movement model to server system 22). As shown in FIG. 4, server system 22 may implement process 70 in an iterative manner (returning from step 82 to step 72), such as by iteratively performing process 70 at different locations on a journey of vehicle 10.

Example 1: A method comprising: while a mobile asset is in use during a current mobile asset reservation, receiving, by a computing system, mobile asset usage information for the current mobile asset reservation; prior to the mobile asset being returned, predicting, by the computing system and based on the mobile asset usage information, a future return time for the mobile asset, wherein the return time is a time at which a current user of the mobile asset returns the mobile asset to an assigned return location; and selectively adjusting, by the computing system and based on the future return time, a future reservation for the mobile asset.

Example 2: The method of Example 1, wherein the mobile asset usage information comprises heuristic data associated with the current user.

Example 3: The method of Example 1, wherein the mobile asset usage information comprises real-time traffic information associated with a current location of the mobile asset and/or a surrounding area of the assigned return location.

Example 4: The method of any of Examples 1-3, wherein selectively adjusting the future reservation comprises extending, by the computing system and based on the future return time, a mobile asset pickup time window of the future reservation.

Example 5: The method of any of Examples 1-3, wherein selectively adjusting the future reservation comprises changing, by the computing system and based on the future return time, a vehicle type of the future reservation.

Example 6: A computing system comprising: a communications interface configured to receive mobile asset usage information for a current mobile asset reservation while a mobile asset is in use during the current mobile asset reservation; a memory configured to store the mobile asset usage information for the current mobile asset reservation; and processing circuitry in communication with the communications interface and the memory. The processing circuitry is configured to: predict, prior to the mobile asset being returned, and based on the mobile asset usage information stored to the memory, a future return time for the mobile asset, wherein the return time is a time at which a current user of the mobile asset returns the mobile asset to an assigned return location; and selectively adjust, based on the future return time, a future reservation for the mobile asset.

Example 7: The computing system of Example 6, wherein the mobile asset usage information comprises heuristic data associated with the current user.

Example 8: The computing system of Example 6, wherein the mobile asset usage information comprises real-time traffic information associated with a current location of the mobile asset and/or a surrounding area of the assigned return location.

Example 9: The computing system of any of Examples 6-8, wherein to selectively adjust the future reservation, the processing circuitry is configured to extend, based on the future return time, a mobile asset pickup time window of the future reservation.

Example 10: The computing system of any of Examples 6-8, wherein to selectively adjust the future reservation, the processing circuitry is configured to change, based on the future return time, a vehicle type of the future reservation.

Example 11: An apparatus comprising: means for receiving, while a mobile asset is in use during a current mobile asset reservation, mobile asset usage information for the current mobile asset reservation; means for predicting, prior to the mobile asset being returned, based on the received mobile asset usage information, a future return time for the mobile asset, wherein the return time is a time at which a current user of the mobile asset returns the mobile asset to an assigned return location; and means for selectively adjusting, based on the future return time, a future reservation for the mobile asset.

Example 12: The apparatus of Example 11, wherein the mobile asset usage information comprises heuristic data associated with the current user.

Example 13: The apparatus of Example 11, wherein the mobile asset usage information comprises real-time traffic information associated with a current location of the mobile asset and/or a surrounding area of the assigned return location.

Example 14: The apparatus of any of Examples 11-13, wherein the means for selectively adjusting the future reservation comprise means for extending, based on the future return time, a mobile asset pickup time window of the future reservation.

Example 15: The apparatus of any of Examples 11-13, wherein the means for selectively adjusting the future reservation comprise means for changing, based on the future return time, a vehicle type of the future reservation.

Example 16: A non-transitory computer-readable storage medium encoded with instructions that, when executed, cause processing circuitry of a computing system to: receive mobile asset usage information for a current mobile asset reservation while a mobile asset is in use during the current mobile asset reservation; predict, prior to the mobile asset being returned, and based on the received mobile asset usage information stored, a future return time for the mobile asset, wherein the return time is a time at which a current user of the mobile asset returns the mobile asset to an assigned return location; and selectively adjust, based on the future return time, a future reservation for the mobile asset.

Example 17: The non-transitory computer-readable storage medium of Example 16, wherein the mobile asset usage information comprises heuristic data associated with the current user.

Example 18: The non-transitory computer-readable storage medium of Example 16, wherein the mobile asset usage information comprises real-time traffic information associated with a current location of the mobile asset and/or a surrounding area of the assigned return location.

Example 19: The non-transitory computer-readable storage medium of any of Examples 16-18, wherein the instructions that cause the processing circuitry to selectively adjust the future reservation comprise instructions that, when executed, cause the processing circuitry to extend, based on the future return time, a mobile asset pickup time window of the future reservation.

Example 20: The non-transitory computer-readable storage medium of any of Examples 6-8, wherein the instructions that cause the processing circuitry to selectively adjust the future reservation comprise instructions that, when executed, cause the processing circuitry to change, based on the future return time, a vehicle type of the future reservation.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable data storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units.

Various examples have been described. These and other examples are within the scope of the following claims.

1. A method comprising:
while a mobile asset is in use during a current mobile asset reservation, receiving, by a computing system, mobile asset usage information for the current mobile asset reservation;
prior to the mobile asset being returned, predicting, by the computing system and based on the mobile asset usage information, a future return time for the mobile asset, wherein the return time is a time at which a current user of the mobile asset returns the mobile asset to an assigned return location; and
selectively adjusting, by the computing system and based on the future return time, a future reservation for the mobile asset.

2. The method of claim 1, wherein the mobile asset usage information comprises heuristic data associated with the current user.

3. The method of claim 1, wherein the mobile asset usage information comprises real-time traffic information associated with a current location of the mobile asset and/or a surrounding area of the assigned return location.

4. The method of claim 1, wherein selectively adjusting the future reservation comprises extending, by the computing system and based on the future return time, a mobile asset pickup time window of the future reservation.

5. The method of claim 1, wherein selectively adjusting the future reservation comprises changing, by the computing system and based on the future return time, a vehicle type of the future reservation.

6. A computing system comprising:
a communications interface configured to receive mobile asset usage information for a current mobile asset reservation while a mobile asset is in use during the current mobile asset reservation;
a memory configured to store the mobile asset usage information for the current mobile asset reservation; and
processing circuitry in communication with the communications interface and the memory, the processing circuitry being configured to:
predict, prior to the mobile asset being returned, and based on the mobile asset usage information stored to the memory, a future return time for the mobile asset, wherein the return time is a time at which a current user of the mobile asset returns the mobile asset to an assigned return location; and
selectively adjust, based on the future return time, a future reservation for the mobile asset.

7. The computing system of claim 6, wherein the mobile asset usage information comprises heuristic data associated with the current user.

8. The computing system of claim 6, wherein the mobile asset usage information comprises real-time traffic information associated with a current location of the mobile asset and/or a surrounding area of the assigned return location.

9. The computing system of claim 6, wherein to selectively adjust the future reservation, the processing circuitry is configured to extend, based on the future return time, a mobile asset pickup time window of the future reservation.

10. The computing system of claim 6, wherein to selectively adjust the future reservation, the processing circuitry is configured to change, based on the future return time, a vehicle type of the future reservation.

11. An apparatus comprising:
means for receiving, while a mobile asset is in use during a current mobile asset reservation, mobile asset usage information for the current mobile asset reservation;
means for predicting, prior to the mobile asset being returned, based on the received mobile asset usage information, a future return time for the mobile asset, wherein the return time is a time at which a current user of the mobile asset returns the mobile asset to an assigned return location; and
means for selectively adjusting, based on the future return time, a future reservation for the mobile asset.

12. The apparatus of claim 11, wherein the mobile asset usage information comprises heuristic data associated with the current user.

13. The apparatus of claim 11, wherein the mobile asset usage information comprises real-time traffic information associated with a current location of the mobile asset and/or a surrounding area of the assigned return location.

14. The apparatus of claim 11 wherein the means for selectively adjusting the future reservation comprise means for extending, based on the future return time, a mobile asset pickup time window of the future reservation.

15. The apparatus of claim 11, wherein the means for selectively adjusting the future reservation comprise means for changing, based on the future return time, a vehicle type of the future reservation.

16. A non-transitory computer-readable storage medium encoded with instructions that, when executed, cause processing circuitry of a computing device to:
receive mobile asset usage information for a current mobile asset reservation while a mobile asset is in use during the current mobile asset reservation;
predict, prior to the mobile asset being returned, and based on the received mobile asset usage information stored, a future return time for the mobile asset, wherein the return time is a time at which a current user of the mobile asset returns the mobile asset to an assigned return location; and
selectively adjust, based on the future return time, a future reservation for the mobile asset.

17. The non-transitory computer-readable storage medium of claim 16, wherein the mobile asset usage information comprises heuristic data associated with the current user.

18. The non-transitory computer-readable storage medium of claim 16, wherein the mobile asset usage information comprises real-time traffic information associated with a current location of the mobile asset and/or a surrounding area of the assigned return location.

19. The non-transitory computer-readable storage medium of claim 16, wherein the instructions that cause the processing circuitry to selectively adjust the future reservation comprise instructions that, when executed, cause the processing circuitry to extend, based on the future return time, a mobile asset pickup time window of the future reservation.

20. The non-transitory computer-readable storage medium of claim 16, wherein the instructions that cause the processing circuitry to selectively adjust the future reservation comprise instructions that, when executed, cause the processing circuitry to change, based on the future return time, a vehicle type of the future reservation.
